(19) United States
(12) Patent Application Publication
(10) Pub. No.: US 2026/0066805 A1
(43) Pub. Date: Mar. 5, 2026

(54) SINGLE-STAGE POWER CONVERSION DEVICE

(71) Applicant: MetaPWR Electronics Co., Ltd., Shanghai (CN)

(72) Inventors: Da Jin, Shanghai (CN); Yahong Xiong, Shanghai (CN)

(73) Assignee: MetaPWR Electronics Co., Ltd., Shanghai (CN)

(21) Appl. No.: 19/303,332

(22) Filed: Aug. 18, 2025

(30) Foreign Application Priority Data
Sep. 4, 2024 (CN) 202411231080.1
Feb. 6, 2025 (CN) 202510132408.2

(51) Int. Cl. H02M 3/335; H02M 1/00

(52) U.S. Cl. CPC H02M 3/33592; H02M 1/0064; H02M 3/33573

(57) ABSTRACT

A single-stage power conversion device is provided. The single-stage power conversion device includes an input positive terminal, an input negative end, an output positive terminal, an output negative end, a primary side circuit and a secondary side circuit. The primary side circuit adopts two groups of full-bridge circuit parallel architectures, and the secondary side circuit adopts N synchronous rectification units and N inductors, and N is a natural number with a multiple of 4; and the four inductors included in the secondary side circuit are reversely coupled in the same inductor magnetic core.

### CROSS-REFERENCE TO RELATED APPLICATION

This application claims the priority benefit of China application serial no. CN202411231080.1 filed on Sep. 4, 2024, and China application serial no. CN202510132408.2 filed on Feb. 6, 2025. The entirety of each of the above-mentioned patent applications is hereby incorporated by reference herein and made a part of this specification.

### BACKGROUND

### Description of Related Art

In recent years, with the development of technologies such as data centers, artificial intelligence, supercomputers and the like, more and more ASIC with powerful functions are applied, such as a CPU, a GPU, a machine learning accelerator, a network switch, a server and the like, which consume a large amount of current, for example, reach thousands of amperes. In order to meet the rapid response to load dynamic, a two-stage converter, namely a front-stage proportional converter (converting a 48V bus into a 12V bus or even a lower)+post-stage voltage regulator, is adopted in the industry at present (the voltage regulator often adopts multi-phase Buck phase-shifted parallel connection, and the rapid response to the load can be easily realized) voltage conversion from 48V to 1V is realized. However, due to the existence of the low-voltage bus (12V), large conduction loss can be generated, the efficiency of the whole machine is low, and the application is relatively complex.

In the second mode, a single-stage power converter is adopted to remove the 12V bus, 48V is directly converted to 1V or lower, the conversion efficiency of the power conversion assembly of the single-stage converter is high, and the power density is high; however, the output inductor of the single-stage converter is often integrated in the transformer, so that the transformer cannot be optimally designed, and low conduction loss and good dynamic performance cannot be obtained at the same time.

Therefore, the development of a power conversion assembly and an electronic device to solve the problems faced by the existing technologies is the indeed and urgent issue to be addressed in this field.

### SUMMARY

In view of the above, one of the objectives of the application is to provide a single-stage power conversion device, comprising:
an input positive terminal, an input negative end, an output positive terminal, an output negative end, a primary side circuit and a secondary side circuit;
the primary side circuit comprises a first primary side sub-circuit and a second primary side sub-circuit which are connected in parallel; the secondary side circuit comprises a first secondary side circuit and a second secondary side circuit which are electrically connected in parallel, the first secondary side circuit and the second secondary side circuit both comprise a synchronization unit and an inductor, the synchronization unit comprises a first synchronization unit and a second synchronization unit, and the inductor comprises a first inductor and a second inductor;
each of the first synchronization unit and the second synchronization unit comprises a unit positive terminal and a unit negative end; the first inductor is bridged between the unit positive terminal and the output positive terminal, and the second inductor is bridged between the unit negative end and the output negative end;
four inductors included in the first secondary side circuit and the second secondary side circuit are reversely coupled and are arranged in a first inductor magnetic core; and the first inductor and the second inductor are bridged between a synchronization unit and an output positive terminal or an output negative end.

Preferably, the first synchronization unit further comprises a first synchronous rectification (SR) combination and a secondary winding; the second synchronization unit further comprises a second SR combination and a secondary winding, and each secondary winding comprises a first secondary winding and a second secondary winding; and each SR combination comprises a first synchronous rectification switch and a second synchronous rectification switch with a common source electrode; in the same synchronization unit, the first end of each secondary winding is electrically connected to the unit positive terminal, the second end of the first secondary winding is electrically connected with the drain of the first synchronous rectification switch, and the second end of the second secondary winding is electrically connected with the drain of the second synchronous rectification switch; and the source electrode of each synchronous rectification switch is electrically connected to the unit negative end; the unit positive terminal of the first synchronization unit is electrically connected with the first end of the first inductor, the second end of the first inductor is electrically connected with the output positive terminal, and the unit negative end of the first synchronization unit is electrically connected with the output negative end; the unit positive terminal of the second synchronization unit is electrically connected with the output positive terminal, the unit negative end of the second synchronization unit is electrically connected with the first end of the second inductor, and the second end of the second inductor is electrically connected with the output negative end.

Preferably, the first primary side sub-circuit comprises a first primary winding, the second primary side sub-circuit comprises a second primary winding, the first primary winding and the four secondary windings in the first secondary side circuit are coupled in the same transformer magnetic core, the second primary winding and the four secondary windings in the second secondary side circuit are coupled in the same transformer magnetic core.

Preferably, the first inductor magnetic core comprises four inductor winding columns and an inductor middle column, and the four inductor winding columns are arranged around the inductor middle column; and the four inductors are wound on one inductor winding column respectively.

Preferably, the first ends of the inductors wound on two adjacent inductor winding columns are electrically connected with the first synchronization unit and the second synchronization unit respectively, and the second ends of the inductors wound on the two adjacent inductor winding columns are electrically connected with the output positive terminal and the output negative end respectively.

Preferably, the direct-current magnetic flux directions on each inductor winding column are the same.

Preferably, the power conversion device further comprises two transformer magnetic cores, and the two transformer magnetic cores are arranged on the two opposite sides of the first inductor magnetic core; each transformer magnetic core comprises two transformer side columns and a transformer winding column, and the transformer winding column is arranged between the two transformer side columns; and the primary winding is wound N circles around the transformer winding column, and each secondary winding is wound a half circle around the transformer winding column.

Preferably, the transformer magnetic core comprises a first side and a third side opposite to each other, and a second side and a fourth side opposite to each other; and the third side of the transformer magnetic core is arranged adjacent to the first inductor magnetic core; and the first end and the second end of the primary winding are arranged adjacent to the third side; the first ends of the two secondary windings of the first synchronization unit are arranged adjacent to the third side, and the second ends of the two secondary windings of the first synchronization unit are arranged adjacent to the first side; the first ends of the two secondary windings of the second synchronization unit are arranged adjacent to the first side, and the second ends of the two secondary windings of the second synchronization unit are arranged adjacent to the third side.

Preferably, the power conversion device further comprises a third secondary side circuit and a fourth secondary side circuit, the third secondary side circuit and the fourth secondary side circuit both comprise a synchronization unit and an inductor, the synchronization unit comprises a first synchronization unit and a second synchronization unit, and the inductor comprises a first inductor and a second inductor; and each synchronization unit comprises a unit positive terminal and a unit negative end; the first inductor is bridged between the positive unit terminal and the output positive terminal, and the second inductor is bridged between the unit negative end and the output negative end; the four inductors in the third secondary side circuit and the fourth secondary side circuit are reversely coupled and are arranged in the second inductor magnetic core; and the first inductor and the second inductor are connected between the synchronization unit and the output positive terminal or the output negative end in a bridging mode.

Preferably, the power conversion device further comprises two transformer magnetic cores, and the first inductor magnetic core and the second inductor magnetic core are arranged between the two transformer magnetic cores; each transformer magnetic core comprises two transformer side columns and two transformer winding columns, the transformer winding columns are arranged between the two transformer side columns, and the two transformer winding columns and the two transformer side columns are arranged in a linear mode; and the primary winding sequentially winds N circles around each transformer winding column; and four secondary windings in each secondary side circuit wind a half circle around one transformer winding column respectively, and each transformer winding column is wound with four secondary windings in a secondary side circuit.

Preferably, each primary side sub-circuit further comprises a first primary side switch, a second primary side switch, a third primary side switch and a fourth primary side switch, the first primary side switch and the second primary side switch are connected in series to form a first switch bridge arm, the third primary side switch and the fourth primary side switch are connected in series to form a second switch bridge arm, the drain electrodes of the first primary side switch and the third primary side switch are electrically connected with the input positive terminal, and the source electrodes of the second primary side switch and the fourth primary side switch are electrically connected with the input negative end; the first end of the primary winding is electrically connected with the midpoint of the first switch bridge arm, and the second end of the primary winding is electrically connected with the midpoint of the second switch bridge arm.

Preferably, a first end of each primary winding, a first end of each first secondary winding, and a second end of each second secondary winding have the same polarity, and are marked as point ends.

Preferably, the power conversion device further comprises a first control signal, a second control signal, a third control signal, a fourth control signal, a fifth control signal, a sixth control signal, a seventh control signal and an eighth control signal; the duty ratio of the first control signal, the second control signal, the third control signal and the fourth control signal is equal, and the first control signal, the second control signal, the third control signal and the fourth control signal are sequentially staggered by 90 degrees; the fifth control signal and the first control signal are complementary, the sixth control signal and the second control signal are complementary, the seventh control signal and the third control signal are complementary, and the eighth control signal and the fourth control signal are complementary; the first control signal is used for controlling the turn-on and turn-off of the first primary side switch and the fourth primary side switch in the first primary side sub-circuit, the second control signal is used for controlling the turn-on and turn-off of the first primary side switch and the fourth primary side switch in the second primary side sub-circuit, the third control signal is used for controlling the turn-on and turn-off of the second primary side switch and the third primary side switch in the first primary side sub-circuit, and the fourth control signal is used for controlling the turn-on and turn-off of the second primary side switch and the third primary side switch in the second primary side sub-circuit; the fifth control signal is used for controlling the turn-on and turn-off of the two second synchronous rectification switches in the first secondary side circuit, the sixth control signal is used for controlling the turn-on and turn-off of the two second synchronous rectification switches in the second secondary side circuit, the seventh control signal is used for controlling the turn-on and turn-off of the two first synchronous rectification switches in the first secondary side circuit, and the eighth control signal is used for controlling the turn-on and turn-off of the two first synchronous rectification switches in the second secondary side circuit.

Preferably, the power conversion device further comprises a third secondary side circuit and a fourth secondary side circuit, and the third secondary side circuit and the fourth secondary side circuit both comprise a first synchronization unit and a second synchronization unit; and each synchronization unit comprises a first synchronous rectification switch and a second synchronous rectification switch with a common source; the fifth control signal is used for controlling the turn-on and turn-off of two second synchronous rectification switches in the third secondary side circuit, the sixth control signal is used for controlling the turn-on and turn-off of two second synchronous rectification switches in the fourth secondary side circuit, the seventh control signal is used for controlling the turn-on and turn-off of two first synchronous rectification switches in the third secondary side circuit, and the eighth control signal is used for controlling the turn-on and turn-off of two first synchronous rectification switches in the fourth secondary side circuit.

A single-stage power conversion device, comprising:
an input end, an output end and a power conversion sub-circuit, wherein the power conversion sub-circuit comprises a first primary winding, a second primary winding, a first secondary side circuit, a second secondary side circuit and a four-phase inductor;
the first secondary side circuit comprises a first synchronization unit and a second synchronization unit, and the second secondary side circuit comprises a third synchronization unit and a fourth synchronization unit; each synchronization unit comprises two secondary windings; the first primary winding, two secondary windings in the first synchronization unit and two secondary windings in the second synchronization unit are magnetically coupled in a first transformer magnetic core; and the second primary winding, two secondary windings in the third synchronization unit and two secondary windings in the fourth synchronization unit are magnetically coupled in a second transformer magnetic core;
the four-phase inductor comprises four inductor windings, the four inductor windings are coupled in the same inductor magnetic core, and the four inductors comprise a first inductor winding, a second inductor winding, a third inductor winding and a fourth inductor winding; the first inductor winding, the second inductor winding, the third inductor winding and the fourth inductor winding are sequentially and reversely coupled in pairs; the fourth inductor winding and the first inductor winding are reversely coupled;
the input end comprises an input positive terminal and an input negative end, and the output end comprises an output positive terminal and an output negative end;
each of the synchronization units has a unit positive terminal and a unit negative end; the first inductor winding is bridged between the output positive terminal and the unit positive terminal of the first synchronization unit, and the unit negative end of the first synchronization unit and the output negative end are electrically connected; the second inductor winding is bridged between the output negative end and the unit negative end of the first synchronization unit, and the unit positive terminal of the second synchronization unit and the output positive terminal are electrically connected; the third inductor winding is bridged between the output positive terminal and the unit positive terminal of the third synchronization unit, and the unit negative end of the third synchronization unit and the output negative end are electrically connected; the fourth inductor winding is bridged between the output negative end and the unit negative end of the fourth synchronization unit, and the unit positive terminal of the fourth synchronization unit and the output positive terminal are electrically connected;
the inductor magnetic core is disposed between the first transformer magnetic core and the second transformer magnetic core.

Preferably, the first synchronization unit comprises a first SR combination, the second synchronization unit comprises a second SR combination, the third synchronization unit comprises a first SR combination, and the fourth synchronization unit comprises a second SR combination; each SR combination comprises a first synchronous rectification switch and a second synchronous rectification switch with a common source; the two secondary windings are respectively a first secondary winding and a second secondary winding; and in each synchronization unit, the source electrode of each synchronous rectification switch is electrically connected with the unit negative end of the synchronization unit, the drain of the first synchronous rectification switch is electrically connected with the second end of the first secondary winding, and the drain of the second synchronous rectification switch is electrically connected with the second end of the second secondary winding; and the first end of the first secondary winding and the first end of the second secondary winding are electrically connected with the unit positive terminal.

Preferably, the first transformer magnetic core and the second transformer magnetic core both comprise a first side and a third side opposite to each other, a second side and a fourth side opposite to each other, two transformer side columns and a transformer winding column; the third side of the first transformer magnetic core and the third side of the second transformer magnetic core are adjacent to the inductor magnetic core; the first SR combination of the first synchronization unit is arranged adjacent to the first side of the first transformer magnetic core; the first SR combination of the third synchronization unit is arranged adjacent to the first side of the second transformer magnetic core; the second SR combination of the second synchronization unit is arranged adjacent to the third side of the first transformer magnetic core; and the second SR combination of the fourth synchronization unit is adjacent to the third side of the second transformer magnetic core.

Preferably, the single-stage power conversion device, further comprising a circuit substrate,
wherein the circuit substrate comprises an upper surface and a lower surface opposite to each other and a plurality of hole grooves, and each hole groove penetrates through the upper surface and the lower surface; and the plurality of hole grooves comprise transformer winding column hole grooves; and the primary winding and the secondary winding are both arranged in the circuit substrate and/or on the surface of the circuit substrate, and are wound around the corresponding transformer winding column hole groove; the first transformer magnetic core and the second transformer magnetic core both penetrate through the corresponding hole grooves, and buckle the circuit substrate from the upper surface and the lower surface respectively;
the synchronous rectification switch is arranged on the upper surface and/or the lower surface; the inductor magnetic core comprises four inductor winding columns and an inductor middle column, and the four inductor winding columns are arranged around the inductor middle column; the plurality of hole grooves comprise four inductor winding column hole grooves allowing the inductor winding columns to penetrate through; and the four inductor windings are wound around the corresponding inductor winding column hole grooves respectively.

Preferably, the single-stage power conversion device, further comprising a first primary side switch combination and a second primary side switch combination,
wherein the first primary side switch combination is electrically connected with the first primary side winding, and the second primary side switch combination is electrically connected with the second primary side winding; the primary side switch combination is arranged on the upper surface of the circuit substrate, the first primary side switch combination is arranged adjacent to the first transformer magnetic core, and the second primary side switch combination is arranged adjacent to the second transformer magnetic core.

Preferably, the single-stage power conversion device, further comprising an output end combination, wherein the output end combination is arranged on the lower surface of the circuit substrate and is adjacent to the second side, the fourth side or the outer side of the first SR combination.

Preferably, the single-stage power conversion device, further comprising a signal end combination, an input end, and an input capacitor,
wherein the signal end combination, the input end, and the input capacitor are arranged on the lower surface of the circuit substrate, and the signal end combination is arranged adjacent to the first SR combination; the input end is arranged adjacent to the inductor magnetic core, and the input capacitor is arranged adjacent to the input end; and the input end and the input capacitor are arranged adjacent to the first primary side switch combination and the second primary side switch combination.

Preferably, at least two power conversion sub-circuits are provided; the first primary winding corresponding to each power conversion sub-circuit is electrically connected to each other; the second primary winding corresponding to each power conversion sub-circuit is electrically connected to each other; and
the first primary winding in each power conversion sub-circuit, two secondary windings in the first synchronization unit and two secondary windings in the second synchronization unit are magnetically coupled in the first transformer magnetic core; and the second primary winding in each power conversion sub-circuit, two secondary windings in the third synchronization unit and two secondary windings in the fourth synchronization unit are magnetically coupled in the second transformer magnetic core.

Preferably, in each power conversion sub-circuit, the first synchronization unit comprises a first SR combination, the second synchronization unit comprises a second SR combination, the third synchronization unit comprises another first SR combination, and the fourth synchronization unit comprises another second SR combination; each SR combination comprises a first synchronous rectification switch and a second synchronous rectification switch with a common source;
in each synchronization unit, the two secondary windings are respectively a first secondary winding and a second secondary winding; and the first end of the first secondary winding is in short connection with the first end of the second secondary winding and is electrically connected to the unit positive terminal; the second end of the first secondary winding is electrically connected with the drain of the first synchronous rectification switch, the second end of the second secondary winding is electrically connected with the drain of the second synchronous rectification switch; and the source of the first synchronous rectification switch and the source of the second synchronous rectification switch are in short connection and are electrically connected to the unit negative end.

Preferably, the at least two inductor magnetic cores are arranged in the X-axis direction; the first transformer magnetic core and the second transformer magnetic core both comprise a first side and a third side opposite to each other, and a second side and a fourth side opposite to each other; the third side of the first transformer magnetic core and the third side of the second transformer magnetic core are adjacent to the inductor magnetic core;
a first SR combination of the first synchronization unit, the first transformer magnetic core, a second SR combination of the second synchronization unit, the inductor magnetic core, a second SR combination of the fourth synchronization unit, the second transformer magnetic core and a first SR combination of the third synchronization unit are sequentially arranged in the Y-axis direction;
the first transformer magnetic core comprises two first transformer side columns and at least two first transformer winding columns; the first transformer side columns are arranged on the two sides; each power conversion sub-circuit corresponds to one of the first transformer winding columns; the first primary side winding, the secondary winding combination of the first synchronization unit and the secondary winding of the second synchronization unit are wound on the corresponding first transformer winding column;
the second transformer magnetic core comprises two second transformer side columns and at least two second transformer winding columns, and the second transformer side columns are arranged on the two sides; each power conversion sub-circuit corresponds to one of the second transformer winding columns; the second primary winding, the secondary winding combination of the third synchronization unit and the secondary winding of the forth synchronization unit are wound on the corresponding second transformer winding column;
the winding directions of the first primary windings of the adjacent power conversion sub-circuits are opposite; and the winding directions of the second primary windings of the adjacent power conversion sub-circuits are opposite.

Preferably, the single-stage power conversion device, further comprising a circuit substrate, wherein the circuit substrate comprises an upper surface and a lower surface opposite to each other and a plurality of hole grooves, and each hole groove penetrates through the upper surface and the lower surface; and the plurality of hole grooves comprise at least four transformer winding column hole grooves; the primary winding and the secondary winding are both arranged in the circuit substrate and/or on the surface of the circuit substrate, and the primary winding and the secondary winding are respectively wound around the corresponding transformer winding column hole grooves; the first transformer magnetic core and the second transformer magnetic core both penetrate through the corresponding hole grooves, and buckle the circuit substrate from the upper surface and the lower surface respectively;
the synchronous rectification switch is arranged on the upper surface and/or the lower surface; each inductor magnetic core comprises four inductor winding columns and an inductor middle column, the multiple hole grooves comprise at least eight inductor winding column hole grooves, and the four inductor windings in each inductor magnetic core are wound around the corresponding inductor winding column hole grooves respectively.

Preferably, the single-stage power conversion device, further comprising a first primary side switch combination and a second primary side switch combination,
wherein the first primary windings of the at least two power conversion sub-circuits are connected in series and are electrically connected to the first primary side switch combination; the second primary windings of the at least two power conversion sub-circuits are connected in series and are electrically connected to the second primary switch combination; the at least two power conversion sub-circuits share the same first transformer magnetic core, and the at least two power conversion sub-circuits share the same second transformer magnetic core; and the first primary side switch combination and the second primary side switch combination are arranged adjacent to the same side of the first transformer magnetic core and the same side of the second transformer magnetic core.

Preferably, the first secondary side circuits in the adjacent power conversion sub-circuits are arranged in a mirror-symmetric device layout; and the second secondary side circuits in the adjacent power conversion sub-circuits are arranged in a mirror-symmetric device layout.

Preferably, the single-stage power conversion device, further comprising an output end combination, wherein the output end combination is arranged on the lower surface of the circuit substrate; a part of the output end combination is arranged adjacent to the second side and the fourth side of each inductor magnetic core, and the other part of the output end combination is arranged adjacent to the first SR combination.

Preferably, the single-stage power conversion device, further comprising a signal end combination, an input end, and an input capacitor,
wherein the signal end combination, the input end and the input capacitor are arranged on the lower surface of the circuit substrate, and the signal end combination is arranged adjacent to the first SR combination; the input end is arranged adjacent to the inductor magnetic core, and the input capacitor is arranged adjacent to the input end; and the input end and the input capacitor are arranged adjacent to the first primary side switch combination and the second primary side switch combination.

Preferably, in the adjacent power conversion sub-circuits, synchronous rectification switches in a mirror symmetry position are controlled by the same control signal.

Preferably, the single-stage power conversion device, further comprising an adapter plate, wherein the first SR combination is arranged on the upper surface and the lower surface of the circuit substrate in a symmetrical manner; the adapter plate is arranged below the circuit substrate; and the adapter plate is used for rewiring the input end and the output end.

Compared with the prior art, the application has the following beneficial effects:
(1) The application provides a high-power requirement power conversion circuit. A primary side circuit adopts two groups of full-bridge circuit parallel architectures, the secondary side circuit adopts N synchronous rectification units and N inductors, and N is a natural number of a multiple of 4; through innovative component layout, reverse coupling of the four inductors is realized, the size of the inductor assembly is reduced, and the dynamic performance is improved.
(2) On the other hand, due to the independent design of the transformer and the inductor, the transformer secondary winding adopts a half-ring structure, so that the length of the transformer winding is greatly reduced, low on-resistance is obtained, and the conversion efficiency of the power conversion device is improved.

### BRIEF DESCRIPTION OF THE DRAWINGS

FIG. 1 is a schematic diagram of a power conversion circuit.

FIG. 2 is a control timing sequence of a power conversion circuit.

FIG. 3A to FIG. 3C are schematic diagrams of winding of a primary winding and a secondary winding according to Embodiment 1.

FIG. 4A and FIG. 4B are schematic diagrams of winding of a primary winding and a secondary winding according to Embodiment 2.

FIG. 5A is a schematic diagram of a top surface of a power conversion device.

FIG. 5B is a schematic diagram of a bottom surface of a power conversion device.

FIG. 6A to FIG. 6D are three-dimensional schematic diagrams and exploded schematic diagrams of a power conversion device.

### DESCRIPTION OF THE EMBODIMENTS

One of the cores of the present application is to provide a power conversion circuit and a power conversion device.

The application provides a power conversion circuit meeting high-power requirements. A primary circuit adopts two groups of full-bridge circuit parallel architectures, the secondary circuit adopts N synchronous rectification units and N inductors, and N is a natural number of a multiple of 4; the four inductors are reversely coupled in the same inductor magnetic core, and the size of the inductor assembly is reduced; and on the other hand, the application provides a power conversion device, reverse coupling of four inductors is achieved through component layout, the dynamic response speed of the load is increased, the parasitic loss in the power conversion device is reduced, the high-power output requirement is met, and meanwhile the conversion efficiency of the power conversion device is improved.

According to the technical scheme in the embodiment of the application, the technical scheme in the embodiment of the application is clearly and completely described below in combination with the drawings in the embodiment of the application, obviously, the described embodiments are only a part but not all of the embodiments of the present application, all other embodiments obtained by a person of ordinary skill in the art based on the embodiments of the present application without creative efforts shall fall within the protection scope of the present application.

### Embodiment 1

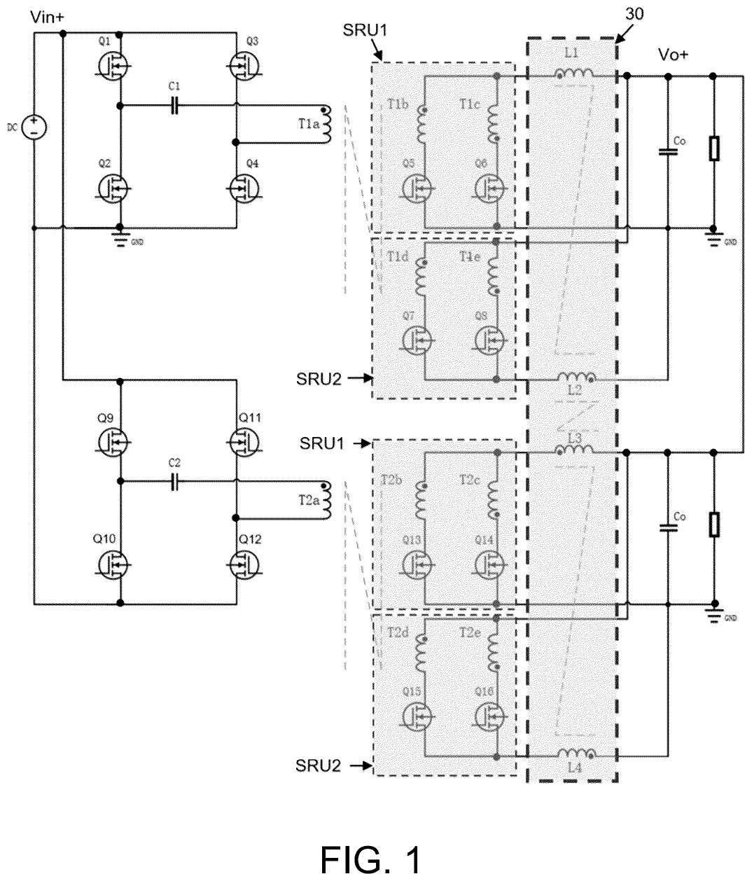

The application provides a single-stage power conversion circuit, as shown in FIG. 1. The power conversion circuit comprises an input positive terminal Vin+, an input negative end Vin−, an output positive terminal Vo+, an output negative end Vo−, a primary side circuit and a secondary side circuit. In the embodiment, the input negative end Vin− and the output negative end Vo− are short-circuited. The primary side circuit adopts two primary side sub-circuits which are electrically connected in parallel, the secondary side circuit comprises a first secondary side circuit and a second secondary side circuit which are electrically connected in parallel, and the first secondary side circuit and the second secondary side circuit both adopt parallel architecture of a plurality of groups of center tap synchronous rectification circuits which are electrically connected in parallel. Each primary side sub-circuit comprises four primary side switches, a blocking capacitor and a primary winding; each primary side sub-circuit is bridged between the input positive terminal and the input negative end; every two primary side switches are connected in series to form a switch bridge arm; and the blocking capacitor and the primary winding are connected in series between the midpoints of the two bridge arms. The secondary side circuit comprises four synchronous rectification units (referred to synchronization units for short) and four inductors; each synchronization unit comprises two synchronous rectification switches and two secondary windings, and each synchronization unit is electrically connected in series with a inductor, and then synchronization units are electrically connected in parallel, and are bridged between the output positive terminal and the output negative end. In another embodiment, a blocking capacitor may not be included, and two ends of the primary winding are directly bridged between the midpoints of the two bridge arms. In the embodiment, each primary side sub-circuit is a full-bridge circuit. In another embodiment, one switch bridge arm can also be a capacitor bridge arm, and the capacitor bridge arm comprises two primary side capacitors connected in series; and after the blocking capacitor and the primary winding are connected in series, the blocking capacitor is bridged between the midpoint of the switch bridge arm and the midpoint of the capacitor bridge arm.

In detail, as shown in FIG. 1, the first primary side sub-circuit comprises a first switch bridge arm, a second switch bridge arm, a blocking capacitor C1 and a primary winding T1a. The first switch bridge arm comprises primary side switches Q1 and Q2, and the primary side switches Q1 and Q2 are connected in series to the midpoint of the bridge arm. The second switch bridge arm comprises primary switches Q3 and Q4, and the primary switches Q3 and Q4 are connected in series to the midpoint of the bridge arm. The blocking capacitor C1 and the primary winding T1a are connected in series between the midpoints of the two bridge arms, the first end of the primary winding T1a is electrically connected to the midpoint of the first switching bridge arm through the blocking capacitor C1, and the second end of the primary winding is electrically connected with the midpoint of the second switching bridge arm. The second primary side sub-circuit comprises a first switch bridge arm, a second switch bridge arm, a blocking capacitor C2 and a primary winding T2a, wherein the first switch bridge arm comprises primary switches Q9 and Q10, and the primary switches Q9 and Q10 are connected in series to a midpoint of the first switch bridge arm; the second switch bridge arm comprises primary switches Q11 and Q12, and the primary switches Q11 and Q12 are connected in series to the midpoint of the second switch bridge arm. The connection mode of the second primary side sub-circuit is the same as the connection mode of the first primary side sub-circuit, the blocking capacitor C2 and the primary winding T2a are connected in series between the midpoint of the first switch bridge arm and the midpoint of the second switch bridge arm, the first end of the primary side winding T2a is electrically connected to the midpoint of the first switching bridge arm through the blocking capacitor C2, and the second end of the primary side winding T2a is electrically connected with the midpoint of the second switching bridge arm.

The first secondary side circuit comprises a first synchronization unit SRU1, a second synchronization unit SRU2, an inductor L1 and an inductor L2. The first synchronization unit SRU1 comprises a unit positive terminal, a unit negative end, a first SR combination (equivalent to synchronous rectification switches Q5 and Q6, hereinafter referred to as a first SR combination for short), and secondary winding T1b and T1c. The source electrodes of the synchronous rectification switches Q5 and Q6 are electrically connected to the unit negative end and are electrically connected with the output negative end; the drain electrode of the synchronous rectification switch Q5 is electrically connected with the second end of the secondary winding T1b, the drain electrode of the synchronous rectification switch Q6 is electrically connected with the second end of the secondary winding T1c, and the first end of the secondary winding T1b and the first end of the secondary wingding T1c are electrically connected to the unit positive terminal. The inductor L1 is bridged between the unit positive terminal and the output positive terminal Vo+; the first end of the inductor L1 is short-circuited with the unit positive terminal, and the second end of the inductor L1 is short-circuited with the output positive terminal Vo+. The second synchronization unit SRU2 comprises a unit positive terminal, a unit negative end and a second SR combination (equivalent to synchronous rectification switches Q7 and Q8), and secondary windings T1d and T1e. The source electrodes of synchronous rectification switches Q7 and Q8 are electrically connected to the unit negative end; the drain electrode of the synchronous rectification switch Q7 is electrically connected with the second end of the secondary winding T1d, and the drain electrode of the synchronous rectification switch Q8 is electrically connected with the second end of the secondary winding T1e; and the first ends of the secondary windings T1d and T1e are electrically connected to the unit positive terminal and are electrically connected with the output positive terminal Vo+. The inductor L2 is bridged between the unit negative end and the output negative end Vo−; the first end of the inductor L2 is short-circuited with the unit negative end, and the second end of the inductor L2 is short-circuited with the output negative end Vo−.

The second secondary side circuit comprises a first synchronization unit SRU1, a second synchronization unit SRU2, an inductor L3 and an inductor L4, wherein the first synchronization unit SRU1 comprises a unit positive terminal, a unit negative end, a first SR combination (equivalent to synchronous rectification switches Q13 and Q14), and secondary windings T2b and T2c. The source electrodes of synchronous rectification switches Q13 and Q14 are electrically connected to the unit negative end and are electrically connected with the output negative end; the drain electrode of the synchronous rectification switch Q13 is electrically connected with the second end of the secondary winding T2b, the drain electrode of the synchronous rectification switch Q14 is electrically connected with the second end of the secondary winding T2c, and the first end of the secondary side winding T2b and the first end of the T2c are electrically connected to the unit positive terminal. The inductor L3 is bridged between the unit positive terminal and the output positive terminal Vo+; and the first end of the inductor L3 is short-circuited with the unit positive terminal, and the second end of the inductor L3 and the output positive terminal Vo+ are short-circuited. The second synchronization unit SRU2 comprises a unit positive terminal, a unit negative end, a second SR combination (equivalent to synchronous rectification switches Q15 and Q16), and secondary side windings T2d and T2e. The source electrodes of synchronous rectification switches Q15 and Q16 are electrically connected to the unit negative terminal; the drain electrode of the synchronous rectification switch Q15 is electrically connected with the second end of the secondary winding T2d, and the drain electrode of the synchronous rectification switch Q16 is electrically connected with the second end of the secondary winding T2e; and the first ends of the secondary windings T2d and T2e are electrically connected to the unit positive terminal and electrically connected with the output positive terminal Vo+. The inductor L4 is bridged between the unit negative end and the output negative end Vo−; and the first end of the inductor L4 is short-circuited with the unit negative end, and the second end of the inductor L4 and the output negative end Vo− are short-circuited.

In the power conversion circuit disclosed by the embodiment, the primary winding T1a and the secondary winding T1b, T1c, T1d and T1e are coupled together to form an ideal transformer; the first end of the primary winding T1a, the first end of the secondary winding T1b, the second end of the T1c, the first end of the secondary winding T1d, and the second end of the secondary winding T1e have the same polarity and are marked as a point end. The primary winding T2a and the secondary winding T2b, T2c, T2d and T2e are coupled together to form an ideal transformer. The first end of the primary winding T2a, the first end of the secondary winding T2b, the second end of the secondary winding T2c, the first end of the secondary winding T2d, and the second end of the secondary winding T2e have the same polarity and are marked as point ends. The inductors L1, L2, L3 and L4 are reversely coupled. A first end of the inductor L1, a second end of the inductor L2, a first end of the inductor L3 and a second end of the inductor L4 have the same polarity and are marked as point ends.

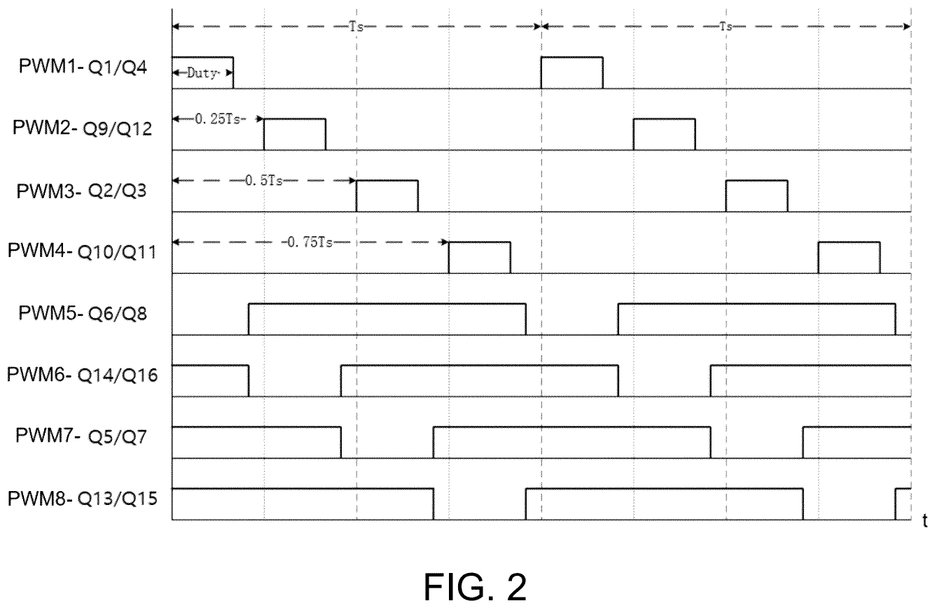

FIG. 2 shows a control time sequence corresponding to the power conversion circuit; the power conversion circuit adopts eight control signals which are respectively a first control signal PWM1, a second control signal PWM2, a third control signal PWM3, a fourth control signal PWM4, a fifth control signal PWM5, a sixth control signal PWM6, a seventh control signal PWM7 and an eighth control signal PWM8, wherein the duty ratio of the first control signal PWM1, the second control signal PWM2, the third control signal PWM3 and the fourth control signal PWM4 (i.e. the duty ratio of the power conversion circuit) is equal, and the four control signals are sequentially staggered by 90 degrees. The first control signal PWM1 is used for controlling the turn-on and turn-off of the primary switches Q1 and Q4, the second control signal PWM2 is used for controlling the turn-on and turn-off of the primary switches Q9 and Q12, the third control signal PWM3 is used for controlling the turn-on and turn-off of the primary switches Q2 and Q3, and the fourth control signal PWM4 is used for controlling the turn-on and turn-off of the primary switches Q10 and Q11. The dead time between the control signals is ignored, and the fifth control signal PWM5 is complementary to the first control signal PWM1 and is used for controlling the turn-on and turn-off of the synchronous rectification switches Q6 and Q8. The sixth control signal PWM 6 is complementary to the second control signal PWM2 and is used for controlling the turn-on and turn-off of the synchronous rectification switches Q14 and Q16; the seventh control signal PWM7 is complementary to the third control signal PWM3 and is used for controlling the turn-on and turn-off of the synchronous rectification switches Q5 and Q7; and the eighth control signal PWM8 is complementary to the fourth control signal PWM4 and is used for controlling the turn-on and turn-off of the synchronous rectification switches Q13 and Q15. In the embodiment, the duty ratio is any value between 0 and 0.5, and the duty ratio can be adjusted according to the output voltage through the control element.

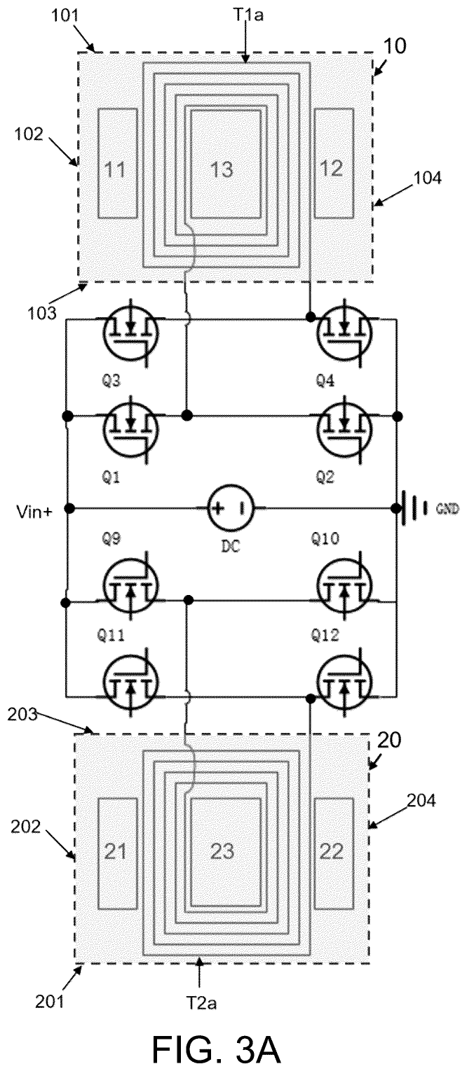

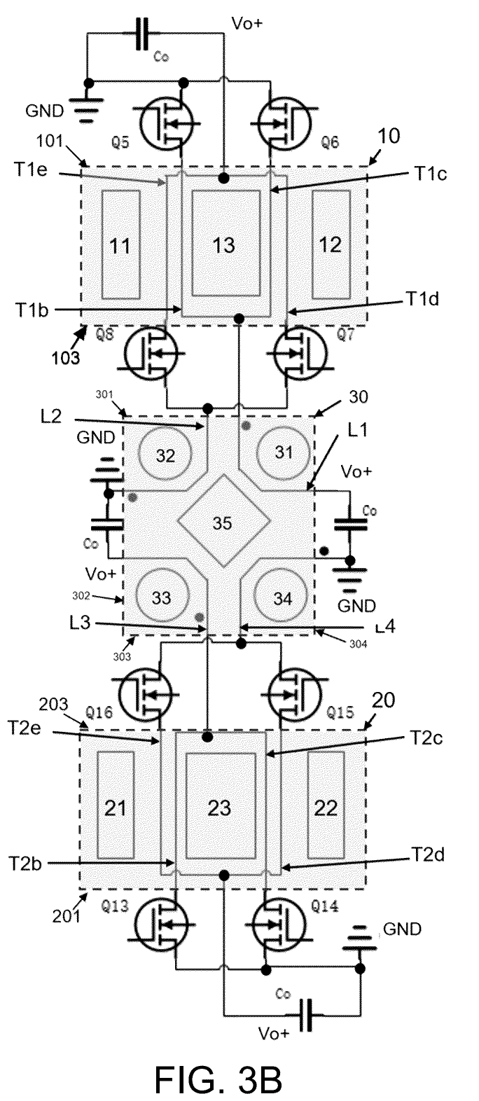

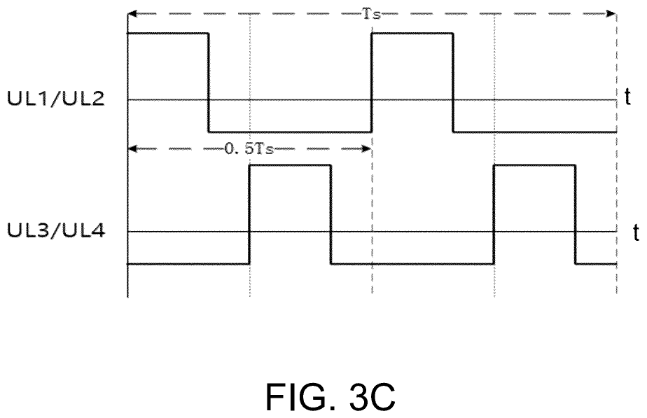

The power conversion device disclosed by the application adopts the circuit topology shown in FIG. 1 and the control time sequence shown in FIG. 2. In the embodiment, the power conversion device comprises a first transformer assembly 10, a second transformer assembly 20 and an inductor assembly 30. As shown in FIG. 3A and FIG. 3B, FIG. 3A is a winding mode of a primary winding and a connection mode of the primary winding and a primary switch. FIG. 3B is a winding mode of a secondary winding, a connection mode of the secondary winding and a synchronous rectification switch, a winding mode and a connection mode of the inductor winding. The inductor assembly 30 is arranged between the two transformer assemblies, and the primary switch is arranged on the same side of the two transformer assemblies.

The first transformer assembly 10 comprises a first transformer magnetic core, a primary winding T1a, and a secondary winding T1b/T1c/T1d/T1e. The first transformer magnetic core comprises transformer side columns 11 and 12 and a transformer winding column 13; the first transformer magnetic core is an E-shaped magnetic core, and further comprises a first side 101 and a third side 103 opposite to each other, a second side 102 and a fourth side 104 opposite to each other, wherein the second side 102 is located on the left side of the third side 103, and the fourth side 104 is located on the right side of the third side 103. As shown in FIG. 3A, the first end and the second end of the primary winding T1a are both arranged adjacent to the third side 103 of the first transformer magnetic core, the first end is arranged adjacent to the transformer side column 11, and the second end is arranged adjacent to the transformer side column 12; the primary side winding T1a is wound N circles around the transformer winding column 13 in the first direction (in the embodiment, the first direction is a clockwise direction) from the first end to the second end. As shown in FIG. 3B, the first ends of the secondary winding T1b and the secondary winding T1c are arranged close to the third side 103 of the first transformer magnetic core, and the second ends of the secondary winding T1b and the secondary winding T1c are arranged close to the first side 101 of the first transformer magnetic core. The secondary winding T1b sequentially passes through the third side 103, a channel between the transformer side column 11 and the transformer winding column 13 and the first side 101 (i.e., along a third direction) from the first end to the second end; the secondary side winding T1c sequentially passes through the third side 103, the channel between the transformer side column 12 and the transformer winding column 13 and the first side 101 (i.e., in the third direction) from the first end to the second end. The first ends of the secondary winding T1d and the secondary winding T1e are arranged adjacent to the first side 101 of the first transformer magnetic core, and the second ends of the secondary winding T1d and the secondary winding T1e are arranged adjacent to the third side 103 of the first transformer magnetic core. The secondary winding T1d sequentially passes through the first side 101, a channel between the transformer side column 12 and the transformer winding column 13 and a third side 103 (i.e., in a fourth direction) from the first end to the second end; the secondary side winding T1e sequentially passes through the first side 101, the channel between the transformer side column 11 and the transformer winding column 13 and the third side 103 (i.e., in the fourth direction) from the first end to the second end. In the embodiment, the secondary winding T1b/T1c/T1d/T1e surrounds the transformer winding column 13 to wind a half circle, so that the turns ratio of the primary winding to the secondary winding in the first transformer assembly is 2*N:1:1:1:1. Compared with a traditional transformer, under the condition of obtaining the same turn ratio, the number of turns of the primary winding and the secondary winding in the embodiment is halved, so that the copper loss generated on the transformer winding is effectively reduced, and the conversion efficiency of the power conversion device is further improved. Here, the first direction is opposite to the second direction, and the third direction is opposite to the fourth direction.

Similarly, the second transformer assembly 20 comprises a second transformer magnetic core, a primary winding T2a, a secondary winding T2b/T2c/T2d/T2e. The second transformer magnetic core is an E-shaped magnetic core and comprises transformer side columns 21 and 22 and a transformer winding column 23, and the second transformer magnetic core further comprises a first side 201 and a third side 203 opposite to each other, a second side 202 and a fourth side 204 opposite to each other; the second side 202 is located on the left side of the third side 203, and the fourth side 204 is located on the right side of the third side 203; the third side 203 of the second transformer magnetic core is opposite to and adjacent to the third side 103 of the first transformer magnetic core; a first side 101 and a third side 103 of the first transformer magnetic core, a third side 203 and a first side 201 of the second transformer magnetic core are sequentially arranged from top to bottom. As shown in FIG. 3A, the first end and the second end of the primary winding T2a are both arranged adjacent to the third side 203 of the second transformer magnetic core, the first end is arranged adjacent to the transformer side column 21, and the second end is arranged adjacent to the transformer side column 22; the primary side winding T2a is wound N circles around the transformer winding column 23 in the second direction from the first end to the second end (in the embodiment, the second direction is a counterclockwise direction). As shown in FIG. 3B, the first ends of the secondary winding T2b and the secondary winding T2c are arranged close to the third side 203 of the second transformer magnetic core, and the second ends of the secondary winding T2b and the secondary winding T2c are arranged close to the first side 201 of the second transformer magnetic core. The secondary winding T2b sequentially passes through the third side 203, a channel between the transformer side column 21 and the transformer winding column 23 and a first side 201 (i.e., in a fourth direction) from the first end to the second end; the secondary winding T2c sequentially passes through the third side 203, a channel between the transformer side column 22 and the transformer winding column 23 and the first side 201 (i.e., in the fourth direction) from the first end to the second end. The first end of the secondary winding T2d and the secondary winding T2e are both arranged adjacent to the first side 201 of the second transformer magnetic core, and the second end of the secondary winding T2d and the secondary winding T2e are both arranged adjacent to the third side 203 of the second transformer magnetic core. The secondary winding T2d sequentially passes through the first side 201, a channel between the transformer side column 22 and the transformer winding column 23 and a third side 203 (i.e., along a third direction) from the first end to the second end; the secondary side winding T2e sequentially passes through the first side 201, a channel between the transformer side column 21 and the transformer winding column 23 and the third side 203 (i.e., in the third direction) from the first end to the second end. In the embodiment, the secondary winding T2b/T2c/T2d/T2e is wound a half circle around the transformer winding column 23 respectively, so that the turns ratio of the primary winding to the secondary winding in the second transformer assembly is 2*N:1:1:1:1. Compared with a traditional transformer, under the condition of obtaining the same turn ratio, the number of turns of the primary winding and the secondary winding in the embodiment is halved, so that the copper loss generated on the transformer winding is effectively reduced, and the conversion efficiency of the power conversion device is further improved. Here, the first direction is opposite to the second direction, and the third direction is opposite to the fourth direction.

In the embodiment, the unit positive terminal of the first synchronization unit SRU1 is electrically connected to the output positive terminal Vo+ through the inductor, and the unit negative end is directly and electrically connected with the output negative end Vo−; the unit positive terminal of the second synchronization unit SRU2 is directly and electrically connected with the output positive terminal Vo+, and the unit negative end is electrically connected to the output negative end Vo−. Therefore, the unit positive terminal of the first synchronization unit and the unit negative end of the second synchronization unit are both arranged adjacent to the inductor assembly 30. According to the layout, the four inductor windings L1/L2/L3/L4 are integrated in the same inductor assembly, and reverse coupling of the four inductors in the secondary side circuit can be realized by utilizing one inductor magnetic core.

Referring to FIG. 3B, a first SR combination of a first secondary side circuit, a first transformer assembly, a second SR combination of a first secondary side circuit, an inductor assembly (including four inductor windings L1/L2/L3/L4), a second SR combination of a second secondary side circuit, a second transformer assembly, and a first SR combination of a second secondary side circuit are sequentially arranged from top to bottom. The inductor assembly 30 comprises an inductor magnetic core and the inductor winding L1/L2/L3/L4. The inductor magnetic core is a five-column magnetic core and comprises four inductor winding columns 31/32/33/34 and an inductor middle column 35, and the four inductor winding columns 31/32/33/34 are arranged around the inductor middle column 35. The inductor magnetic core comprises a first side 301 and a third side 303 opposite to each other, a second side 302 and a fourth side 304 opposite to each other. The second side 302 is located on the left side of the first side 301, and the fourth side 304 is located on the right side of the first side 301. The first side 301 of the inductor magnetic core is adjacent to the third side 103 of the first transformer magnetic core, and the third side 303 of the inductor magnetic core is adjacent to the third side 203 of the second transformer magnetic core. The first end of the inductor winding L1 and the first end of the inductor winding L2 are both arranged adjacent to the first side 301 of the inductor magnetic core; the second end of the inductor winding L1 is arranged adjacent to the fourth side 304 and is electrically connected with the output positive terminal Vo+; and the second end of the inductor winding L2 is arranged adjacent to the second side 302 and is electrically connected with the output negative end Vo−. The first ends of the inductor windings L3 and L4 are arranged adjacent to the third side 303 of the inductor magnetic core; the second end of the inductor winding L3 is arranged adjacent to the second side 302 and is electrically connected with the output positive terminal Vo+; and the second end of the inductor winding L4 is arranged adjacent to the fourth side 304 and is electrically connected with the output negative end Vo−. The inductor winding L1/L2/L3/L4 passes through the channel between the winding column 31/32/33/34 and the middle column 35 from the first end to reach the second end respectively, so that a circle is wound around the inductor winding column 31/32/33/34. Due to the fact that the direct current of the inductor current flows in from the point end, the direct-current magnetic flux direction generated on each winding column is outflow the paper, and the direct-current magnetic flux direction is defined as the positive direction, so that the direct-current magnetic flux direction on each inductor winding column is the same, and the anti-coupling relationship of the four inductors is achieved. The voltage UL at the two ends of the inductor is defined as the point end voltage minus non-point end voltage, and the voltage UL1 at the two ends of the inductor winding L1 is equal to the voltage UL2 at the two ends of the inductor winding L2, the voltage UL3 at the two ends of the inductor winding L3 is equal to the voltage UL4 at the two ends of the inductor winding L4, and the UL1 and the UL3 are staggered by 180 degrees, as shown in FIG. 3C. Therefore, on the inductor middle column 35, direct-current magnetic flux superposition and alternating-current magnetic flux subtraction are carried out, so that a relatively large steady-state inductor and a relatively small dynamic inductor are obtained.

### Embodiment 2

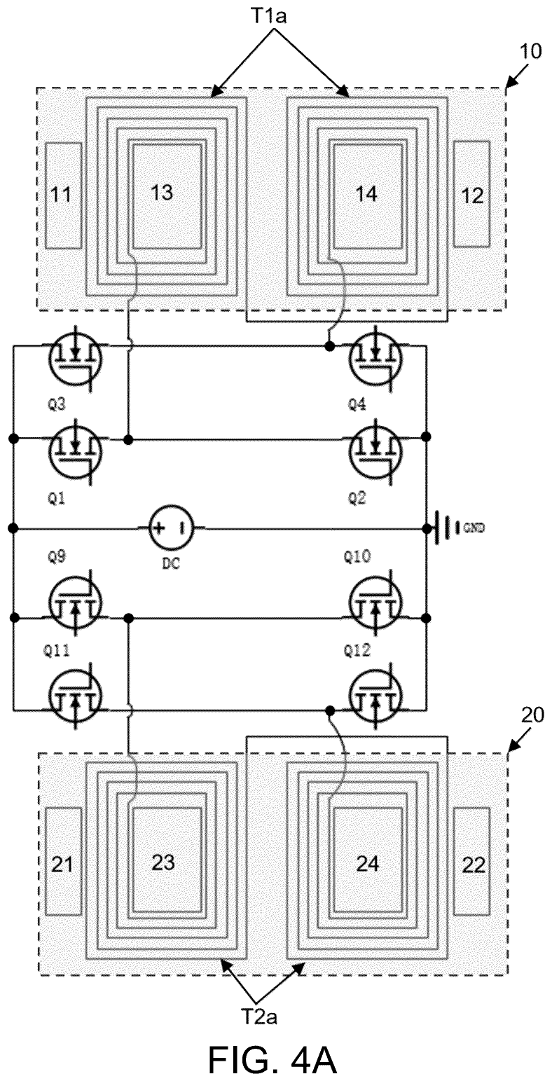

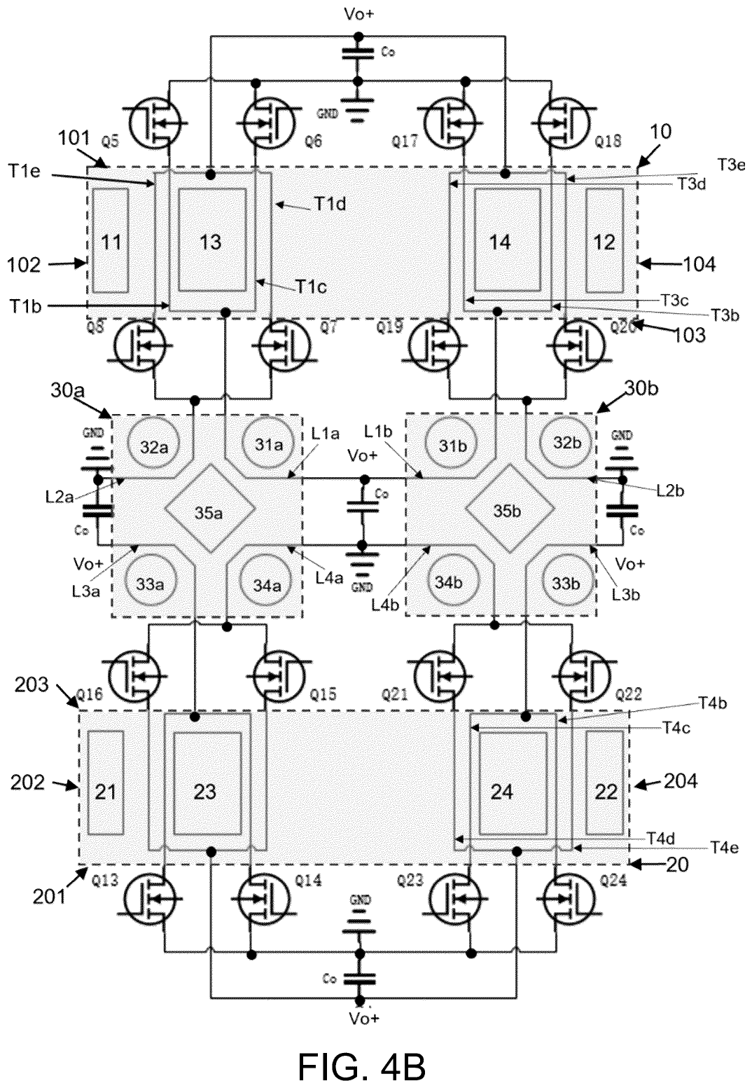

In order to meet the requirement of a load on a large current, the power conversion device needs to further increase the output power. In the embodiment, by adding a group of first secondary side circuits and adding a group of second secondary side circuits, the requirement for increasing the output power can be met by adding one winding column to each transformer magnetic core, as shown in FIG. 4A and FIG. 4B in detail. The transformer assembly 10 comprises transformer side columns 11 and 12, transformer winding columns 13 and 14. The first ends of the primary side windings T1a are arranged adjacent to the transformer side columns 11, and the second ends are arranged adjacent to the transformer side columns 12; and N circles are wound around the transformer winding column 13 in the first direction from the first end to the second end, and then N circles are wound around the transformer winding column 14 in the second direction. Similarly, the transformer assembly 20 comprises transformer side columns 21 and 22, transformer winding columns 23 and 24. The winding mode of the primary winding T2a is similar to the winding mode of the primary winding T1a, the first end of the primary winding T2a is arranged adjacent to the transformer side column 21, and the second end is arranged adjacent to the transformer side column 22; N circles are wound around the transformer winding column 23 in the second direction from the first end to the second end, and then N circles are wound around the transformer winding column 24 in the first direction.

Referring to FIG. 4B, the winding mode of the secondary winding T1b/T1c/T1d/T1e is the same as that of the first embodiment, and the newly added first set of secondary side circuits comprises a secondary winding T3b/T3c/T3d/T3e. The secondary winding T3b/T3c/T3d/T3e is wound half circle around the transformer winding column 14 in a similar manner and coupled with the primary winding wound on the transformer winding column 14. A first end of the secondary winding T3b and a first end of the secondary winding T3c are arranged adjacent to a third side 103 of the first transformer magnetic core and are short-circuited to be a unit positive terminal of the first synchronization unit SRU1, and the unit positive terminal is electrically connected to a first end of the output inductor L1b; and a second end of the secondary winding T3b and a second end of the secondary winding T3c are both arranged adjacent to a first side 101 of the first transformer magnetic core. The secondary winding T3b sequentially passes through the third side 103, a channel between the transformer winding column 14 and the transformer side column 12 and a first side 101 (i.e., in a third direction) from the first end to the second end; the secondary side winding T3c sequentially passes through the third side 103, a channel between the transformer winding columns 13 and 14 and the first side 101 (i.e., in the third direction) from the first end to the second end. A first end of the secondary winding T3d and a first end of the secondary winding T3e are arranged adjacent to the first side 101 of the first transformer magnetic core and are shorted to a unit positive terminal of the second synchronization unit SRU2, that is, an output positive terminal Vo+; and a second end of the secondary winding T3d and a second end of the secondary winding T3e are arranged adjacent to the third side 103 of the first transformer magnetic core. The secondary winding T3d sequentially passes through the first side 101, the channel between the transformer winding columns 13 and 14 and the third side 103 (i.e., in the fourth direction) from the first end to the second end; the secondary side winding T3e sequentially passes through the first side 101, the channel between the transformer side columns 12 and 14 and the third side 103 (i.e., in the fourth direction) from the first end to the second end. Similarly, the second transformer assembly also comprises a transformer winding column 24 and a secondary winding T4b/T4c/T4d/T4e, and the structure and the winding mode thereof are similar to the first transformer assembly in the embodiment, and a similar technical effect can also be obtained, and details are not described herein again.

The newly added first secondary side circuit comprises a newly added synchronous rectification switch Q17/Q18/Q19/Q20, and the source electrode of the synchronous rectification switch Q17/Q18/Q19/Q20 is respectively in short connection with a second end of the secondary winding T3c/T3b/T3d/T3e. The source electrodes of Q17 and Q18 are short-circuited with the unit negative end of the first synchronization unit SRU1, that is, are short-circuited with the output negative terminal; and the source electrodes of Q19 and Q20 are short-circuited with the unit negative terminal of the second synchronous unit SRU2, that is, are short-circuited with the first terminal of the L2b of the output inductor. The new set of second secondary side circuits comprises synchronous rectification switches Q21/Q22/Q23/Q24, and the drain electrodes of the synchronous rectification switches Q21/Q22/Q23/Q24 are respectively in short connection with the second ends of the secondary side windings T4d/T4e/T4b/T4c; and the source electrodes of Q23 and Q24 are short-circuited with the unit negative end of the first synchronization unit SRU1, that is, are short-circuited with the output negative end; and the source electrodes of Q21 and Q22 are short-circuited with the unit negative end of the second synchronization unit SRU2, that is, are short-circuited with the first end of the output inductor L4b. In the first secondary side circuit, synchronous rectification switches Q5 and Q18 in the first SR combination and synchronous rectification switches Q7 and Q19 in the second SR combination are controlled by the same control signal; and synchronous rectification switches Q6 and Q17 in the first SR combination and synchronous rectification switches Q8 and Q20 in the second SR combination are controlled by the same control signal. In the second secondary side circuit, synchronous rectification switches Q13 and Q24 in the first SR combination and synchronous rectification switches Q15 and Q21 in the second SR combination are controlled by the same control signal; and synchronous rectification switches Q14 and Q23 in the first SR combination and synchronous rectification switches Q16 and Q22 in the second SR combination are controlled by the same control signal.

An output inductor in the newly added first secondary side circuit and an output inductor in the newly added second secondary side circuit are integrated in one inductor assembly 30b. In FIG. 4B, the winding method of the inductor assembly 30a is the same as the inductor assembly 30 in the first embodiment, and the inductor assembly 30b and the inductor assembly 30a are symmetrically arranged along the Y axis. The inductor windings L1a/L2a/L3a/L4a are wound a half circle around the inductor winding columns 31a/32a/33a/34a around respectively; and the inductor windings L1b/L2b/L3b/L4b are respectively wound a half circle around the inductor winding columns 31b/32b/33b/34b. However, the layout of the inductor assembly 30a and the inductor assembly 30b is not limited to a symmetrical layout along the y-axis, and a completely same translation layout can also be used, as long as some changes are made according to the output ends provided on the second side or the fourth side of the inductor assembly.

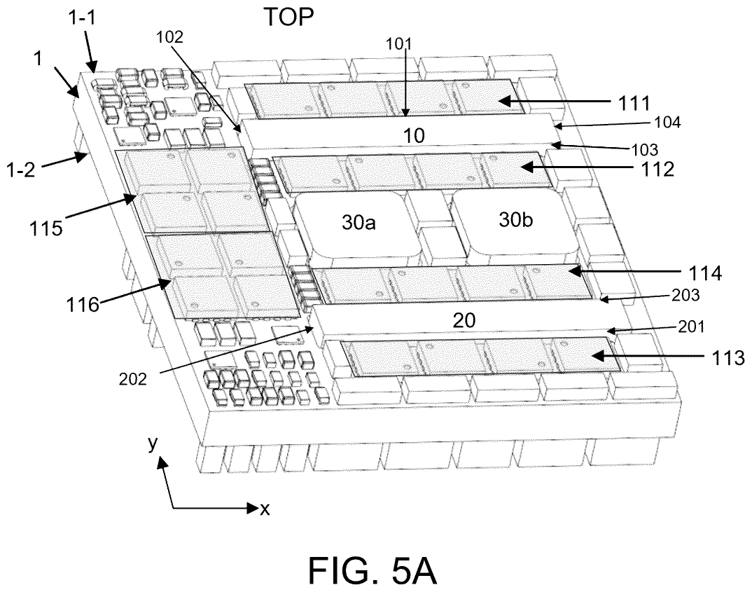

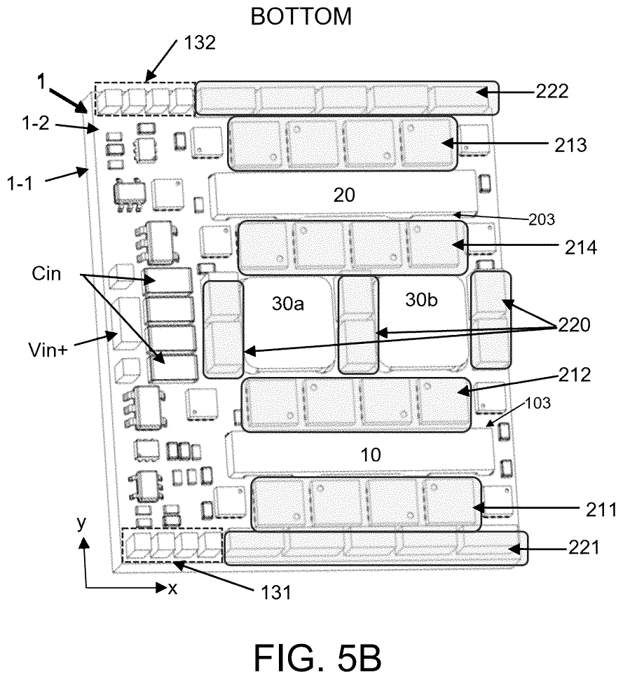

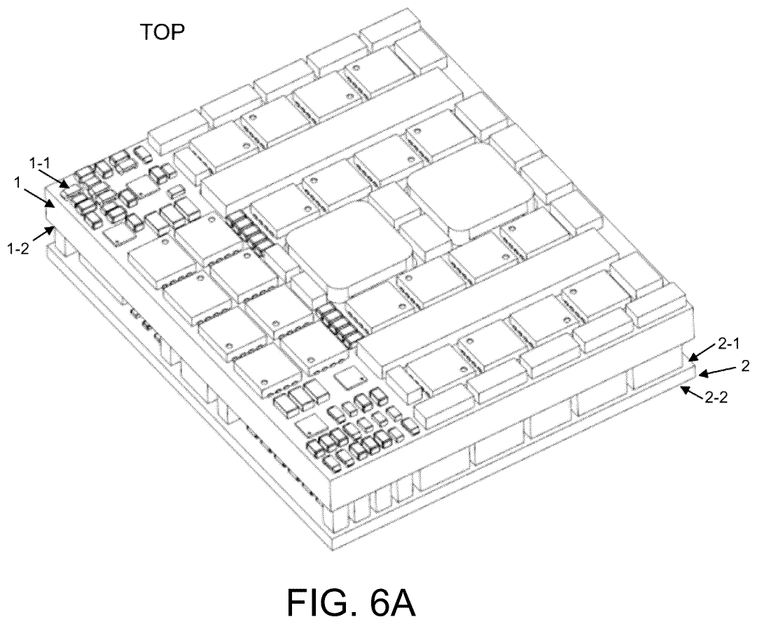

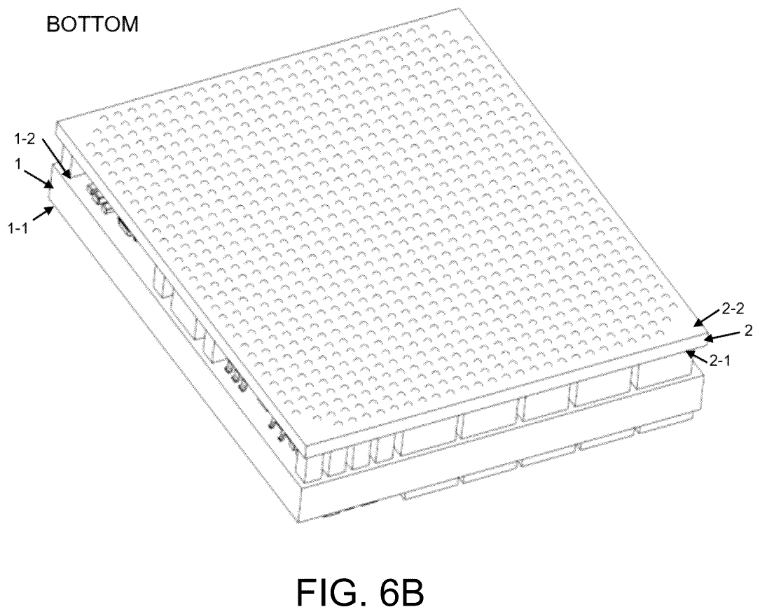

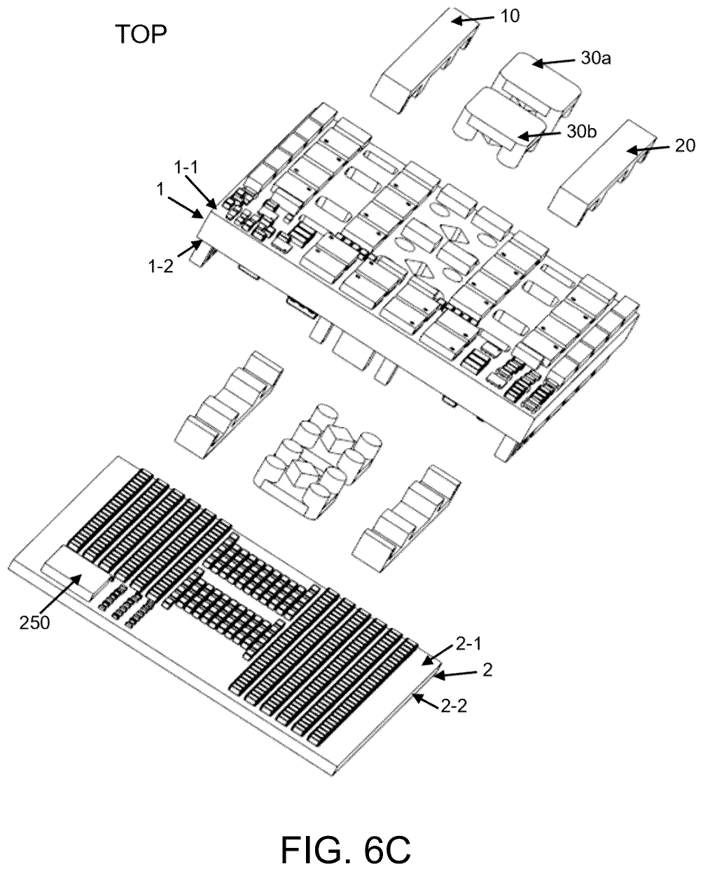

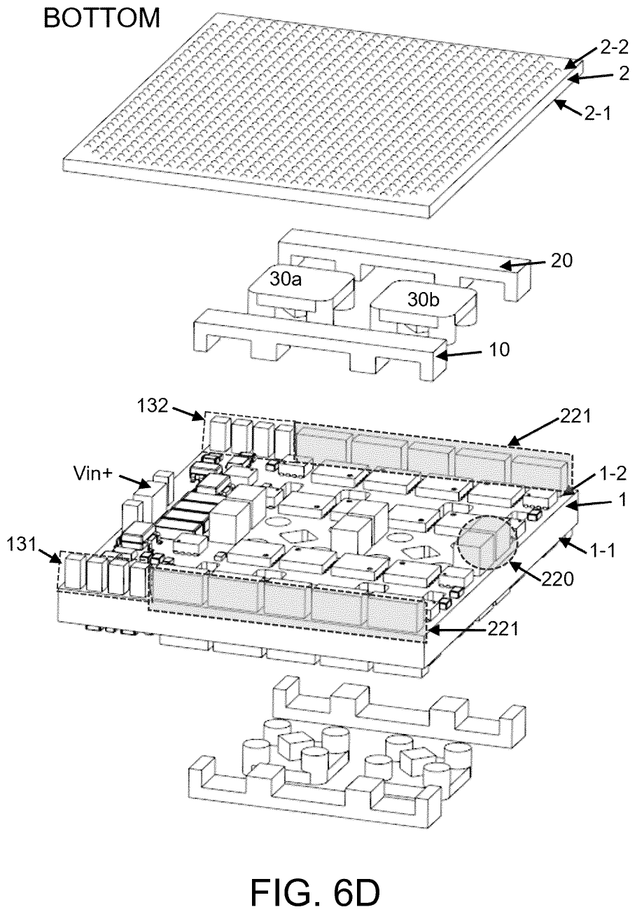

The layout of the power conversion device shown in the embodiment is shown in FIG. 5A and FIG. 5B. FIG. 5A is a schematic diagram of the top surface layout of the power conversion device, and FIG. 5B is a schematic diagram of the layout of the bottom surface of the power conversion device. The power conversion device comprises a circuit substrate 1. The circuit substrate 1 comprises an upper surface 1-1 and a lower surface 1-2 opposite to each other. As shown in FIG. 5A, referring to FIGS. 6C and 6D at the same time, the inductor assemblies 30a and 30b are arranged in the central area of the circuit substrate 1 and are arranged in the X-axis direction. The inductor winding is arranged in the circuit substrate 1 or the surface of the circuit substrate 1. The circuit substrate 1 further comprises a plurality of hole grooves supplying the inductor winding columns and the inductor middle column penetrate through the hole grooves respectively. The inductor magnetic cores are buckled with the circuit substrate 1 from the upper surface 1-1 and the lower surface 1-2 respectively. The plurality hole grooves comprise inductor winding column hole grooves, and each inductor winding is wound around one inductor winding column hole groove. In the Y-axis direction, the transformer assembly 10 and the transformer assembly 20 are respectively arranged on two sides of the circuit substrate, the primary winding and the secondary winding are arranged in the circuit substrate 1 or the surface of the circuit substrate 1, the plurality of hole grooves allow the transformer winding column and the transformer column to penetrate through, the transformer magnetic core is buckled with the circuit substrate 1 from the upper surface 1-1 and the lower surface 1-2 respectively, the plurality of hole grooves comprise transformer winding column hole grooves, and the primary side winding and the secondary side winding are wound around the corresponding transformer winding column hole grooves. A first SR combination 111 (including synchronous rectification switches Q5/Q6/Q17/Q18) of the first secondary side circuit is disposed adjacent to a first side 101 of the transformer assembly 10. A second SR combination 112 of the first secondary side circuit (including a synchronous rectifier switch Q8/Q7/Q19/Q20) is disposed adjacent to a third side 103 of the transformer assembly 10, and a second SR assembly 112 is disposed between the transformer assembly 10 and the inductor assembly 30a/30b. The first SR combination 113 of the second secondary side circuit (including the synchronous rectification switches Q13/Q14/Q23/Q24) is disposed adjacent to the first side 201 of the transformer assembly 20. A second SR combination 114 of a second secondary side circuit (including a synchronous rectification switches Q16/Q15/Q21/Q22) is arranged adjacent to the third side 203 of the transformer assembly 20, and a second SR assembly 114 is arranged between the transformer assembly 20 and the inductor assembly 30a/30b. The primary switch assembly 115 (including Q1/Q2/Q3/Q4) is arranged adjacent to the second side 102 of the transformer assembly 10, and the primary switch assembly 116 (including Q9/Q10/Q11/Q12) is arranged adjacent to the second side 202 of the transformer assembly 20 and the second side of the inductor assembly 30a. In other words, the first SR combination of the first secondary side circuit, the first transformer magnetic core, the second SR combination of the first secondary side circuit, the inductor magnetic core, the second SR combination of the second secondary side circuit, the second transformer magnetic core and the first SR combination of the second secondary side circuit are sequentially arranged in the Y-axis direction.

As shown in FIG. 5B, on the lower surface 1-2 of the substrate 1, the layout of the inductor assembly 30a/30b, the transformer assembly 10 and the transformer assembly 20 is the same as the layout on the upper surface 1-1 of the circuit substrate 1. Similarly, the first SR combination 211 (comprising the synchronous rectification switch Q5/Q6/Q17/Q18) of the first secondary side circuit is arranged adjacent to the first side 101 of the transformer assembly 10; and the synchronous rectification switches in the first SR assembly 211 and the synchronous rectification switches in the first SR assembly 111 on the upper surface 1-1 meet the relationship that the upper and lower positions are in one-to-one direct alignment and in one-to-one electrically connected in parallel. The second SR combination 212 (comprising the synchronous rectification switches Q8/Q7/Q19/Q20) of the first secondary side circuit is arranged adjacent to the third side 103 of the transformer assembly 10; the second SR assembly 212 is arranged between the transformer assembly 10 and the inductor assembly 30a/30b; and the synchronous rectification switches in the second SR assembly 212 and the synchronous rectification switches in the second SR assembly 112 on the upper surface 1-1 meet one-to-one positive pairs at the upper and lower positions and are electrically connected in parallel. The first SR combination 213 (comprising the synchronous rectification switch Q13/Q14/Q23/Q24) of the second secondary circuit is arranged adjacent to the first side 201 of the transformer assembly 20. The synchronous rectification switch in the first SR combination 213 and the synchronous rectification switch in the first SR combination 113 on the upper surface 1-1 meet the relationship that the upper and lower positions are in one-to-one direct alignment and in one-to-one electrically connected in parallel. The second SR combination 214 (comprising the synchronous rectification switches Q16/Q15/Q21/Q22) of the second secondary side circuit is arranged adjacent to the third side 203 of the transformer assembly 20; the second SR assembly 214 is arranged between the transformer assembly 20 and the inductor assembly 30a/30b; and the synchronous rectification switches in the second SR assembly 214 and the synchronous rectification switches in the second SR assembly 114 on the upper surface 1-1 meet the relationship that the upper and lower positions are in one-to-one direct alignment and in one-to-one electrically connected in parallel. In the embodiment, the output end combination 220 comprises a pair of output positive terminal Vo+ and an output negative end Vo−. The output end combination 220 is respectively arranged between the magnetic core assemblies 30a and 30b and the outer side of the magnetic core assemblies 30a and 30b, that is, along the X-axis direction, the output end combination 220, the magnetic core assembly 30a, the output end assembly 220, the magnetic core assembly 30b and the output end combination 220 are sequentially arranged. The output end combination 221 is arranged adjacent to the first SR assembly 211, and the first SR assembly 211 is arranged between the output end combination 221 and the transformer assembly 10; the output end combination 222 is arranged adjacent to the first SR assembly 213, and the first SR assembly 213 is arranged between the output end combination 222 and the transformer assembly 20. The output end combination 221 and 222 comprise an output positive terminal Vo+ and an output negative end Vo−, and the output positive terminal Vo+ and the output negative end Vo− are arranged in a staggered manner. In the embodiment, the output positive terminal Vo+, the output negative end Vo−, the output positive terminal Vo+, the output negative end Vo− and the output positive terminal Vo+ are sequentially arranged. The number and arrangement sequence of the output terminals are not limited thereto, as long as the plurality of terminals are arranged according to the output positive terminal Vo+ and the output negative end Vo− in a staggered manner. The signal end assembly 131 is arranged adjacent to the output end assembly 221, and the signal end assembly 132 is arranged adjacent to the output end assembly 222. The input positive terminal Vin+ is arranged adjacent to the second side of the inductor assembly 30a, and the input capacitor Cin is arranged between the input positive terminal Vin+ and the output terminal combination 220.

In the embodiment, in order to couple the inductor windings in the same inductor magnetic core, the first SR combination, the transformer assembly and the second SR combination in the first secondary side circuit, the first SR, the transformer assembly and the second SR combination in the second secondary side circuit are symmetrically placed on the two sides of the inductor assembly.

The circuit topology shown in the first embodiment can also adopt the layout structure shown in the second embodiment as long as the corresponding components and the added transformer winding columns are removed. Similarly, on the basis of embodiment 2, the secondary side circuit and the transformer winding column can be continuously increased according to the same connection mode and layout rule, so that a larger output power requirement is met.

The power conversion device further comprises a capacitor adapter plate 2, as shown in FIG. 6A to FIG. 6D. FIG. 6A is a three-dimensional schematic diagram of the top surface of the power conversion device, FIG. 6B is a three-dimensional schematic diagram of the bottom surface of the power conversion device, FIG. 6C is a schematic exploded view of the top surface of the power conversion device, and FIG. 6D is a schematic exploded view of the bottom surface of the power conversion device. The capacitor plate 2 comprises an upper surface 2-1 and a lower surface 2-2 opposite to each other, the upper surface 2-1 is provided with a control element 250, and the control element can be a control chip or an MCU. In the embodiment, the control element 250 is an MCU. The control element 250 is disposed adjacent to the signal end 131/132. And other positions of the upper surface 2-1 can be provided with an output capacitor Co according to actual requirements; and the number, the capacitance value, the size or the arrangement position of the output capacitor can be designed according to actual requirements. Referring to FIG. 6D, the height of the output end combination 220/221/222, the signal end 131/132, and the input positive terminal Vin+ is greater than the height of the switch element, or all greater than the height of the transformer magnetic core substrate, or all greater than the height of the inductor magnetic core substrate; further, the height of the output end combination 220/221/222, the signal end 131/132 and the input positive terminal Vin+ is greater than or equal to the sum of the height of the switch element and the height of the output capacitor Co, or all greater than or equal to the sum of the height of the transformer magnetic core substrate and the height of the output capacitor, or all greater than or equal to the sum of the height of the inductor magnetic core substrate and the height of the output capacitor.

A BGA array is designed on the lower surface of the capacitor adapter plate 2, the BGA array is electrically connected with a bonding pad of the upper surface 2-1 through internal wiring or via holes of the capacitor adapter plate 2, and the BGA array is used for transmitting input/output power, partial control signals or sampling signals. The pin position in the BGA array comprises an input positive pin position, an input negative pin position, an output positive pin position, a signal pin position and the like. The layout of the BGA array can be designed according to actual requirements, so that the requirements of different customers are met.

The switch tube disclosed by the application can be used for realizing the functions of the switch disclosed by the application, such as a Si MOSFET, SiC MOSFET, GaN MOSFET or IGBT MOSFET.

The power supply module according to the embodiment can also be a part of the electronic device, and the technical features and advantages disclosed by the application can be met.

The “equal” or “same” or “equal to” disclosed by the application needs to consider the parameter distribution of engineering, and the error distribution is within +/−30%; and the included angle between the two line segments or the two straight lines is less than or equal to 45 degrees; the included angle between the two line segments or the two straight lines is within the range of [60, 120]; and the definition of the phase error phase also needs to consider the parameter distribution of the engineering, and the error distribution of the phase error degree is within +/−30%.

The embodiments in the specification are described in a progressive manner, each embodiment focuses on the difference from other embodiments, and the same similar parts between the embodiments can be referred to each other.

The above description of the disclosed embodiments enables a person skilled in the art to implement or use the present application. Various modifications to these embodiments will be readily apparent to those skilled in the art, and the generic principles defined herein may be implemented in other embodiments without departing from the spirit or scope of the application. Thus, the present application will not be limited to the embodiments shown herein but is to be accorded the widest scope consistent with the principles and novel features disclosed herein.

What is claimed is:

1. A single-stage power conversion device, comprising:
an input positive terminal, an input negative end, an output positive terminal, an output negative end, a primary side circuit and a secondary side circuit;
the primary side circuit comprises a first primary side sub-circuit and a second primary side sub-circuit which are connected in parallel; the secondary side circuit comprises a first secondary side circuit and a second secondary side circuit which are electrically connected in parallel, the first secondary side circuit and the second secondary side circuit both comprise a synchronization unit and an inductor, the synchronization unit comprises a first synchronization unit and a second synchronization unit, and the inductor comprises a first inductor and a second inductor;
each of the first synchronization unit and the second synchronization unit comprises a unit positive terminal and a unit negative end; the first inductor is bridged between the unit positive terminal and the output positive terminal, and the second inductor is bridged between the unit negative end and the output negative end;
four inductors included in the first secondary side circuit and the second secondary side circuit are reversely coupled and are arranged in a first inductor magnetic core; and the first inductor and the second inductor are bridged between a synchronization unit and an output positive terminal or an output negative end.

2. The single-stage power conversion device of claim 1, wherein the first synchronization unit further comprises a first synchronous rectification (SR) combination and a secondary winding;
the second synchronization unit further comprises a second SR combination and a secondary winding, and each secondary winding comprises a first secondary winding and a second secondary winding; and each SR combination comprises a first synchronous rectification switch and a second synchronous rectification switch with a common source electrode;
in the same synchronization unit, the first end of each secondary winding is electrically connected to the unit positive terminal, the second end of the first secondary winding is electrically connected with the drain of the first synchronous rectification switch, and the second end of the second secondary winding is electrically connected with the drain of the second synchronous rectification switch; and the source electrode of each synchronous rectification switch is electrically connected to the unit negative end; the unit positive terminal of the first synchronization unit is electrically connected with the first end of the first inductor, the second end of the first inductor is electrically connected with the output positive terminal, and the unit negative end of the first synchronization unit is electrically connected with the output negative end; the unit positive terminal of the second synchronization unit is electrically connected with the output positive terminal, the unit negative end of the second synchronization unit is electrically connected with the first end of the second inductor, and the second end of the second inductor is electrically connected with the output negative end.

3. The single-stage power conversion device of claim 2, wherein the first primary side sub-circuit comprises a first primary winding, the second primary side sub-circuit comprises a second primary winding, the first primary winding and the four secondary windings in the first secondary side circuit are coupled in the same transformer magnetic core, the second primary winding and the four secondary windings in the second secondary side circuit are coupled in the same transformer magnetic core.

4. The single-stage power conversion device of claim 1, wherein the first inductor magnetic core comprises four inductor winding columns and an inductor middle column, and the four inductor winding columns are arranged around the inductor middle column; and the four inductors are wound on one inductor winding column respectively.

5. The single-stage power conversion device of claim 4, wherein the first ends of the inductors wound on two adjacent inductor winding columns are electrically connected with the first synchronization unit and the second synchronization unit respectively, and the second ends of the inductors wound on the two adjacent inductor winding columns are electrically connected with the output positive terminal and the output negative end, respectively.

6. The single-stage power conversion device of claim 4, wherein the direct-current magnetic flux directions on each inductor winding column are the same.

7. The single-stage power conversion device of claim 2, wherein the power conversion device further comprises two transformer magnetic cores, and the two transformer magnetic cores are arranged on the two opposite sides of the first inductor magnetic core; each transformer magnetic core comprises two transformer side columns and a transformer winding column, and the transformer winding column is arranged between the two transformer side columns; and the primary winding is wound N circles around the transformer winding column, and each secondary winding is wound a half circle around the transformer winding column.

8. The single-stage power conversion device of claim 7, wherein the transformer magnetic core comprises a first side and a third side opposite to each other, and a second side and a fourth side opposite to each other; and the third side of the transformer magnetic core is arranged adjacent to the first inductor magnetic core; and the first end and the second end of the primary winding are arranged adjacent to the third side; the first ends of the two secondary windings of the first synchronization unit are arranged adjacent to the third side, and the second ends of the two secondary windings of the first synchronization unit are arranged adjacent to the first side; the first ends of the two secondary windings of the second synchronization unit are arranged adjacent to the first side, and the second ends of the two secondary windings of the second synchronization unit are arranged adjacent to the third side.

9. The single-stage power conversion device of claim 2, wherein the power conversion device further comprises a third secondary side circuit and a fourth secondary side circuit, the third secondary side circuit and the fourth secondary side circuit both comprise a synchronization unit and an inductor, the synchronization unit comprises a first synchronization unit and a second synchronization unit, and the inductor comprises a first inductor and a second inductor; and each synchronization unit comprises a unit positive terminal and a unit negative end; the first inductor is bridged between the positive unit terminal and the output positive terminal, and the second inductor is bridged between the unit negative end and the output negative end; the four inductors in the third secondary side circuit and the fourth secondary side circuit are reversely coupled and are arranged in the second inductor magnetic core; and the first inductor and the second inductor are connected between the synchronization unit and the output positive terminal or the output negative end in a bridging mode.

10. The single-stage power conversion device of claim 9, wherein the power conversion device further comprises two transformer magnetic cores, and the first inductor magnetic core and the second inductor magnetic core are arranged between the two transformer magnetic cores; each transformer magnetic core comprises two transformer side columns and two transformer winding columns, the transformer winding columns are arranged between the two transformer side columns, and the two transformer winding columns and the two transformer side columns are arranged in a linear mode; and the primary winding sequentially winds N circles around each transformer winding column; and four secondary windings in each secondary side circuit wind a half circle around one transformer winding column respectively, and each transformer winding column is wound with four secondary windings in a secondary side circuit.

11. The single-stage power conversion device of claim 3, wherein each primary side sub-circuit further comprises a first primary side switch, a second primary side switch, a third primary side switch and a fourth primary side switch, the first primary side switch and the second primary side switch are connected in series to form a first switch bridge arm, the third primary side switch and the fourth primary side switch are connected in series to form a second switch bridge arm, the drain electrodes of the first primary side switch and the third primary side switch are electrically connected with the input positive terminal, and the source electrodes of the second primary side switch and the fourth primary side switch are electrically connected with the input negative end; the first end of the primary winding is electrically connected with the midpoint of the first switch bridge arm, and the second end of the primary winding is electrically connected with the midpoint of the second switch bridge arm.

12. The single-stage power conversion device of claim 11, wherein a first end of each primary winding, a first end of each first secondary winding, and a second end of each second secondary winding have the same polarity, and are marked as point ends.

13. The single-stage power conversion device of claim 12, wherein the power conversion device further comprises a first control signal, a second control signal, a third control signal, a fourth control signal, a fifth control signal, a sixth control signal, a seventh control signal and an eighth control signal; the duty ratio of the first control signal, the second control signal, the third control signal and the fourth control signal is equal, and the first control signal, the second control signal, the third control signal and the fourth control signal are sequentially staggered by 90 degrees; the fifth control signal and the first control signal are complementary, the sixth control signal and the second control signal are complementary, the seventh control signal and the third control signal are complementary, and the eighth control signal and the fourth control signal are complementary; the first control signal is used for controlling the turn-on and turn-off of the first primary side switch and the fourth primary side switch in the first primary side sub-circuit, the second control signal is used for controlling the turn-on and turn-off of the first primary side switch and the fourth primary side switch in the second primary side sub-circuit, the third control signal is used for controlling the turn-on and turn-off of the second primary side switch and the third primary side switch in the first primary side sub-circuit, and the fourth control signal is used for controlling the turn-on and turn-off of the second primary side switch and the third primary side switch in the second primary side sub-circuit; the fifth control signal is used for controlling the turn-on and turn-off of the two second synchronous rectification switches in the first secondary side circuit, the sixth control signal is used for controlling the turn-on and turn-off of the two second synchronous rectification switches in the second secondary side circuit, the seventh control signal is used for controlling the turn-on and turn-off of the two first synchronous rectification switches in the first secondary side circuit, and the eighth control signal is used for controlling the turn-on and turn-off of the two first synchronous rectification switches in the second secondary side circuit.

14. The single-stage power conversion device of claim 13, wherein the power conversion device further comprises a third secondary side circuit and a fourth secondary side circuit, and the third secondary side circuit and the fourth secondary side circuit both comprise a first synchronization unit and a second synchronization unit; and each synchronization unit comprises a first synchronous rectification switch and a second synchronous rectification switch with a common source; the fifth control signal is used for controlling the turn-on and turn-off of two second synchronous rectification switches in the third secondary side circuit, the sixth control signal is used for controlling the turn-on and turn-off of two second synchronous rectification switches in the fourth secondary side circuit, the seventh control signal is used for controlling the turn-on and turn-off of two first synchronous rectification switches in the third secondary side circuit, and the eighth control signal is used for controlling the turn-on and turn-off of two first synchronous rectification switches in the fourth secondary side circuit.

15. A single-stage power conversion device, comprising:
an input end, an output end and a power conversion sub-circuit, wherein the power conversion sub-circuit comprises a first primary winding, a second primary winding, a first secondary side circuit, a second secondary side circuit and a four-phase inductor;
the first secondary side circuit comprises a first synchronization unit and a second synchronization unit, and the second secondary side circuit comprises a third synchronization unit and a fourth synchronization unit; each synchronization unit comprises two secondary windings; the first primary winding, two secondary windings in the first synchronization unit and two secondary windings in the second synchronization unit are magnetically coupled in a first transformer magnetic core; and the second primary winding, two secondary windings in the third synchronization unit and two secondary windings in the fourth synchronization unit are magnetically coupled in a second transformer magnetic core;
the four-phase inductor comprises four inductor windings, the four inductor windings are coupled in the same inductor magnetic core, and the four inductor windings comprise a first inductor winding, a second inductor winding, a third inductor winding and a fourth inductor winding; the first inductor winding, the second inductor winding, the third inductor winding and the fourth inductor winding are sequentially and reversely coupled in pairs; the fourth inductor winding and the first inductor winding are reversely coupled;
the input end comprises an input positive terminal and an input negative end, and the output end comprises an output positive terminal and an output negative end;
each of the synchronization units has a unit positive terminal and a unit negative end; the first inductor winding is bridged between the output positive terminal and the unit positive terminal of the first synchronization unit, and the unit negative end of the first synchronization unit and the output negative end are electrically connected; the second inductor winding is bridged between the output negative end and the unit negative end of the first synchronization unit, and the unit positive terminal of the second synchronization unit and the output positive terminal are electrically connected; the third inductor winding is bridged between the output positive terminal and the unit positive terminal of the third synchronization unit, and the unit negative end of the third synchronization unit and the output negative end are electrically connected; the fourth inductor winding is bridged between the output negative end and the unit negative end of the fourth synchronization unit, and the unit positive terminal of the fourth synchronization unit and the output positive terminal are electrically connected;
the inductor magnetic core is disposed between the first transformer magnetic core and the second transformer magnetic core.

16. The single-stage power conversion device of claim 15, wherein the first synchronization unit comprises a first SR combination, the second synchronization unit comprises a second SR combination, the third synchronization unit comprises a first SR combination, and the fourth synchronization unit comprises a second SR combination; each SR combination comprises a first synchronous rectification switch and a second synchronous rectification switch with a common source; the two secondary windings are respectively a first secondary winding and a second secondary winding; and in each synchronization unit, the source electrode of each synchronous rectification switch is electrically connected with the unit negative end of the synchronization unit, the drain of the first synchronous rectification switch is electrically connected with the second end of the first secondary winding, and the drain of the second synchronous rectification switch is electrically connected with the second end of the second secondary winding; and the first end of the first secondary winding and the first end of the second secondary winding are electrically connected with the unit positive terminal.

17. The single-stage power conversion device of claim 16, wherein the first transformer magnetic core and the second transformer magnetic core both comprise a first side and a third side opposite to each other, a second side and a fourth side opposite to each other, two transformer side columns and a transformer winding column; the third side of the first transformer magnetic core and the third side of the second transformer magnetic core are adjacent to the inductor magnetic core; the first SR combination of the first synchronization unit is arranged adjacent to the first side of the first transformer magnetic core; the first SR combination of the third synchronization unit is arranged adjacent to the first side of the second transformer magnetic core; the second SR combination of the second synchronization unit is arranged adjacent to the third side of the first transformer magnetic core; and the second SR combination of the fourth synchronization unit is adjacent to the third side of the second transformer magnetic core.

18. The single-stage power conversion device of claim 17, further comprising a circuit substrate,
wherein the circuit substrate comprises an upper surface and a lower surface opposite to each other and a plurality of hole grooves, and each hole groove penetrates through the upper surface and the lower surface; and the plurality of hole grooves comprise transformer winding column hole grooves; and the primary winding and the secondary winding are both arranged in the circuit substrate and/or on the surface of the circuit substrate, and are wound around the corresponding transformer winding column hole groove; the first transformer magnetic core and the second transformer magnetic core both penetrate through the corresponding hole grooves, and buckle the circuit substrate from the upper surface and the lower surface respectively;
the synchronous rectification switch is arranged on the upper surface and/or the lower surface; the inductor magnetic core comprises four inductor winding columns and an inductor middle column, and the four inductor winding columns are arranged around the inductor middle column; the plurality of hole grooves comprise four inductor winding column hole grooves allowing the inductor winding columns to penetrate through; and the four inductor windings are wound around the corresponding inductor winding column hole grooves respectively.

19. The single-stage power conversion device of claim 17, further comprising a first primary side switch combination and a second primary side switch combination,
wherein the first primary side switch combination is electrically connected with the first primary side winding, and the second primary side switch combination is electrically connected with the second primary side winding; the primary side switch combination is arranged on the upper surface of the circuit substrate, the first primary side switch combination is arranged adjacent to the first transformer magnetic core, and the second primary side switch combination is arranged adjacent to the second transformer magnetic core.

20. The single-stage power conversion device of claim 17, further comprising an output end combination, wherein the output end combination is arranged on the lower surface of the circuit substrate and is adjacent to the second side, the fourth side or the outer side of the first SR combination.

21. The single-stage power conversion device of claim 17, further comprising a signal end combination, an input end, and an input capacitor,
wherein the signal end combination, the input end, and the input capacitor are arranged on the lower surface of the circuit substrate, and the signal end combination is arranged adjacent to the first SR combination; the input end is arranged adjacent to the inductor magnetic core, and the input capacitor is arranged adjacent to the input end; and the input end and the input capacitor are arranged adjacent to the first primary side switch combination and the second primary side switch combination.

22. The single-stage power conversion device of claim 15, wherein at least two power conversion sub-circuits are provided; the first primary winding corresponding to each power conversion sub-circuit is electrically connected to each other; the second primary winding corresponding to each power conversion sub-circuit is electrically connected to each other; and
the first primary winding in each power conversion sub-circuit, two secondary windings in the first synchronization unit and two secondary windings in the second synchronization unit are magnetically coupled in the first transformer magnetic core; and the second primary winding in each power conversion sub-circuit, two secondary windings in the third synchronization unit and two secondary windings in the fourth synchronization unit are magnetically coupled in the second transformer magnetic core.

23. The single-stage power conversion device of claim 22, wherein in each power conversion sub-circuit, the first synchronization unit comprises a first SR combination, the second synchronization unit comprises a second SR combination, the third synchronization unit comprises another first SR combination, and the fourth synchronization unit comprises another second SR combination; each SR combination comprises a first synchronous rectification switch and a second synchronous rectification switch with a common source;
in each synchronization unit, the two secondary windings are respectively a first secondary winding and a second secondary winding; and the first end of the first secondary winding is in short connection with the first end of the second secondary winding and is electrically connected to the unit positive terminal; the second end of the first secondary winding is electrically connected with the drain of the first synchronous rectification switch, the second end of the second secondary winding is electrically connected with the drain of the second synchronous rectification switch; and the source of the first synchronous rectification switch and the source of the second synchronous rectification switch are in short connection and are electrically connected to the unit negative end.

24. The single-stage power conversion device of claim 23, wherein the at least two inductor magnetic cores are arranged in the X-axis direction; the first transformer magnetic core and the second transformer magnetic core both comprise a first side and a third side opposite to each other, and a second side and a fourth side opposite to each other; the third side of the first transformer magnetic core and the third side of the second transformer magnetic core are adjacent to the inductor magnetic core;
a first SR combination of the first synchronization unit, the first transformer magnetic core, a second SR combination of the second synchronization unit, the inductor magnetic core, a second SR combination of the fourth synchronization unit, the second transformer magnetic core and a first SR combination of the third synchronization unit are sequentially arranged in the Y-axis direction;
the first transformer magnetic core comprises two first transformer side columns and at least two first transformer winding columns; the first transformer side columns are arranged on the two sides; each power conversion sub-circuit corresponds to one of the first transformer winding columns; the first primary side winding, the secondary winding combination of the first synchronization unit and the secondary winding of the second synchronization unit are wound on the corresponding first transformer winding column;
the second transformer magnetic core comprises two second transformer side columns and at least two second transformer winding columns, and the second transformer side columns are arranged on the two sides; each power conversion sub-circuit corresponds to one of the second transformer winding columns; the second primary winding, the secondary winding combination of the third synchronization unit and the secondary winding of the forth synchronization unit are wound on the corresponding second transformer winding column;
the winding directions of the first primary windings of the adjacent power conversion sub-circuits are opposite; and the winding directions of the second primary windings of the adjacent power conversion sub-circuits are opposite.

25. The single-stage power conversion device of claim 24, further comprises a circuit substrate, wherein the circuit substrate comprises an upper surface and a lower surface opposite to each other and a plurality of hole grooves, and each hole groove penetrates through the upper surface and the lower surface; and the plurality of hole grooves comprise at least four transformer winding column hole grooves; the primary winding and the secondary winding are both arranged in the circuit substrate and/or on the surface of the circuit substrate, and the primary winding and the secondary winding are respectively wound around the corresponding transformer winding column hole grooves; the first transformer magnetic core and the second transformer magnetic core both penetrate through the corresponding hole grooves, and buckle the circuit substrate from the upper surface and the lower surface respectively;
the synchronous rectification switch is arranged on the upper surface and/or the lower surface; each inductor magnetic core comprises four inductor winding columns and an inductor middle column, the multiple hole grooves comprise at least eight inductor winding column hole grooves, and the four inductor windings in each inductor magnetic core are wound around the corresponding inductor winding column hole grooves respectively.

26. The single-stage power conversion device of claim 22, further comprising a first primary side switch combination and a second primary side switch combination,
wherein the first primary windings of the at least two power conversion sub-circuits are connected in series and are electrically connected to the first primary side switch combination; the second primary windings of the at least two power conversion sub-circuits are connected in series and are electrically connected to the second primary switch combination; the at least two power conversion sub-circuits share the same first transformer magnetic core, and the at least two power conversion sub-circuits share the same second transformer magnetic core; and the first primary side switch combination and the second primary side switch combination are arranged adjacent to the same side of the first transformer magnetic core and the same side of the second transformer magnetic core.

27. The single-stage power conversion device of claim 22, wherein the first secondary side circuits in the adjacent power conversion sub-circuits are arranged in a mirror-symmetric device layout; and the second secondary side circuits in the adjacent power conversion sub-circuits are arranged in a mirror-symmetric device layout.

28. The single-stage power conversion device of claim 24, further comprises an output end combination, wherein the output end combination is arranged on the lower surface of the circuit substrate; a part of the output end combination is arranged adjacent to the second side and the fourth side of each inductor magnetic core, and the other part of the output end combination is arranged adjacent to the first SR combination.

29. The single-stage power conversion device of claim 24, further comprising a signal end combination, an input end, and an input capacitor,
wherein the signal end combination, the input end and the input capacitor are arranged on the lower surface of the circuit substrate, and the signal end combination is arranged adjacent to the first SR combination; the input end is arranged adjacent to the inductor magnetic core, and the input capacitor is arranged adjacent to the input end; and the input end and the input capacitor are arranged adjacent to the first primary side switch combination and the second primary side switch combination.

30. The single-stage power conversion device of claim 27, wherein in the adjacent power conversion sub-circuits, synchronous rectification switches in a mirror symmetry position are controlled by the same control signal.

31. The single-stage power conversion device of claim 18, further comprising an adapter plate, wherein the first SR combination is arranged on the upper surface and the lower surface of the circuit substrate in a symmetrical manner; the adapter plate is arranged below the circuit substrate; and the adapter plate is used for rewiring the input end and the output end.

32. The single-stage power conversion device of claim 25, further comprising an adapter plate, wherein the first SR combination is arranged on the upper surface and the lower surface of the circuit substrate in a symmetrical manner; the adapter plate is arranged below the circuit substrate; and the adapter plate is used for rewiring the input end and the output end.
